(19) United States
(12) Patent Application Publication
(10) Pub. No.: US 2010/0116086 A1
(43) Pub. Date: May 13, 2010

(54) Highly Efficient Universal Connecting Rod

(76) Inventor: Val Licht, Stetsonville, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/465,318

(22) Filed: May 13, 2009

Related U.S. Application Data
(63) Continuation-in-part of application No. 12/321,490, filed on Mar. 17, 2008, now abandoned.

(51) Int. Cl. F16C 7/00; B21D 53/84

(52) U.S. Cl. 74/579 E; 29/888.092

(57) ABSTRACT

A highly efficient universal connecting rod and method of manufacture of a highly efficient universal connecting rod comprised of an connecting rod having an offset longitudinal axis, a first circular aperture used for pivotally attaching the connecting rod to a wrist pin, and a second circular aperture used to pivotally attach said connecting rod to a crankshaft, and a force transfer area creating an angle of offset which directs the line of action to a point away from the center of said second circular aperture in the direction of normal crankshaft rotation.

### CROSS-REFERENCE TO RELATED APPLICATIONS

This application is a continuation-in-part and claims priority to U.S. Non-provisional application Ser. No. 12/321,490 filed on Mar. 17, 2008.

### FIELD OF INVENTION

The present invention relates generally to the field of internal combustion engines, and in particular to a connecting rod.

### BRIEF DESCRIPTION OF THE DRAWINGS

FIG. 1 shows a side perspective view of a traditional connecting rod.

FIG. 2 shows a side perspective view of the highly efficient universal connecting rod.

FIG. 3 shows a side perspective view of the one embodiment of a highly efficient universal connecting rod, further showing the highly efficient universal connecting rod within an internal combustion engine at top dead center.

### GLOSSARY

As used herein, the term “force transfer area” shall refer to a physical gap, void or open area (including curvature and contouring) that eliminates the traditional line of action found in a conventional connecting rod and redirects the force to an offset line of action.

As used herein, the term “force transfer area equation” shall refer to the following equation:

(½)((0.1)(w))(((0.1)(w))(cot θ))

In this equation, w is defined as the radius of the wrist pin. θ is defined as the calculated angle of offset.

As used herein, the term “traditional line of action” is a line of action running from the center point of the wrist pin to the center point of the big end bearing.

As used herein, the term “offset line of action” is a line of action running from the center point of the wrist pin to away from the center of big end bearing in the direction of normal crankshaft rotation and is the result of including a force transfer area in a connecting rod.

As used herein, the term “connecting rod” shall refer to any element or system that connects the piston to the crankshaft using the wrist pin at the piston end, and the big end bearing at the crankshaft end.

As used herein, the term “angle of offset” shall refer to the angle between the traditional line of action and the offset line of action. The minimum value for the angle of offset must be sufficient to create a force transfer area, as defined herein.

As used herein, the term “angle of offset equation” shall refer to the following equation:

θ=arcsine(r/L)

In this equation, L is defined as the distance between the center point of the wrist pin aperture and the center point of the big end bearing aperture. r is defined as the measure of the radius of the big end bearing aperture. θ is defined as the calculated angle of offset.

As used herein, the term “universal” means an apparatus which may be adapted for use in any internal combustion engine using the force transfer area equation and angle of offset equation.

As used herein, the term “force transfer angle” means the angle of offset formed between the offset line of action of the highly efficient universal connecting rod and the traditional line of action of a traditional connecting rod.

As used herein, the term “offset longitudinal axis” refers to the axis of the elongated body of the highly efficient universal connecting rod.

As used herein, the term “line of action” means the path along which the force of an action is transferred.

As used herein, the term “co-linear” means a force that acts in the same line as the line extending through the center point of the wrist pin aperture 122 and the center point of the big end bearing aperture 132.

As used herein, the term “circular” means in the shape of a circle which is substantially circular and does not require that a perfect circle be formed.

### BACKGROUND

In the present art, an internal combustion engine is comprised of at least one cylinder containing a piston connected to a crankshaft through the use of a connecting rod. The pistons in a typical internal combustion engine move in a linear manner Within the cylinders of the engine. In a traditional combustion engine, the connecting rod allows the linear force created by a piston to be transmitted through the body of the connecting rod to a big end bearing, and ultimately to the rotating crankshaft. The crankshaft rotates within the engine and transfers power from the engine.

When ignition occurs within the cylinder, the burning fuel/air mixture expands and the piston is driven toward the crankshaft. The force of the expanding mixture is transferred through the piston, to the wrist pin and through the body of the connecting rod to the big end bearing, and ultimately to the crankshaft. This is accomplished by a mechanical linkage of the components and a force transmitted through the connecting rod that is co-linear to the center line of the crankshaft. With respect to a connecting rod, a co-linear force is inherently inefficient as compared to a torque (offset) force. There have been many attempts in the prior art to create a torque force which would replace the co-linear force of the connecting rod, and create a predictable scientific result based on Newton's laws which predict the resulting force from co-linear versus torque force and the desirability of creating a force perpendicular to the crankshaft

Various attempts have been made to develop an internal combustion engine which uses a connecting rod to produce a torque force rather than a co-linear force to increase the power and efficiency of the engine. For example, U.S. Pat. No. 5,460,505 (the '505 patent) discloses an engine which incorporates an “offset connecting” rod. However, this disclosure fails to enable a functioning offset connecting rod and allow use of the device in an existing combustion engine as for manufacturing a working embodiment of an offset connection rod. While the '505 patent discloses the desirability of using an offset connecting rod, neither the figures included within the patent nor the written description include enabling data to create a working embodiment of an offset connecting rod.

It is known in the art that, as the inventors of the '505 patent claim on their website “[t]he principle of leverage can also be derived using Newton's laws of motion and modern statics.” Upon a reading of the '505 patent it is thus apparent that its drafters have identified a scientific principal of leverage, but have not enabled a specific working embodiment of an apparatus which can be manufactured to implement the generalized scientific principle.

It is therefore desirable to identify a structural configuration that will provide a working embodiment of an offset connecting rod and to provide an enabling disclosure of the calculations which must be performed to create a proven method of manufacture to replicate the working embodiment of the general non-enabling concept disclosed in the '505 patent.

### SUMMARY OF THE INVENTION

The present invention is a highly efficient universal connecting rod comprised of an elongated body having an offset longitudinal axis, a first circular aperture and a second circular aperture. The first circular aperture attaching the offset connecting rod to the wrist pin and the second circular aperture connecting the offset connecting rod to the big end bearing. The offset longitudinal axis of the elongated body of the rod has an angle of offset which creates an force transfer area redirecting the line of action away from the center point of the aperture of the big end bearing. In addition, the present invention is a method of manufacture of a highly efficient universal connecting rod.

### DETAILED DESCRIPTION OF INVENTION

For the purpose of promoting an understanding of the present invention, references are made in the text hereof to embodiments of a highly efficient universal connecting rod, only some of which are described herein. It should nevertheless be understood that no limitations on the scope of the invention are thereby intended. One of ordinary skill in the art will readily appreciate that modifications such as the dimensions of the connecting rod, alternate but functionally similar material(s) from which the connecting rod is made, and the inclusion of additional elements are deemed readily apparent and obvious to one of ordinary skill in the art, and all equivalent relationships to those described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

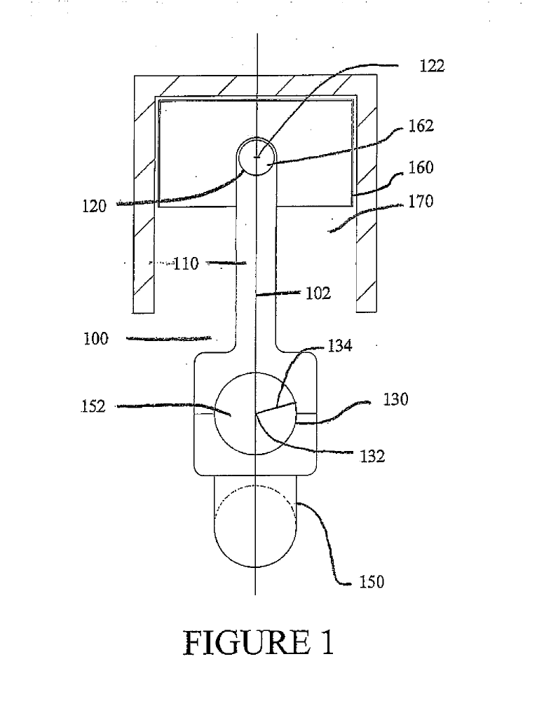

Referring now to the drawings, FIG. 1 is a side perspective view of a traditional connection rod 100 which shows traditional line of action 102. The traditional connecting rod 100 is fitted within cylinder 170 and is connected to piston 160 through wrist pin 162. The traditional connecting rod 100 then connects to crankshaft 150 through the big end bearing 152. The traditional connecting rod 100 has an elongated rod body 110 co-linear to the traditional line of action 102 extending between wrist pin aperture 120 and big end bearing aperture 130. The wrist pin aperture having a center point 122 and the big end bearing aperture having a center point 132 and radius 134.

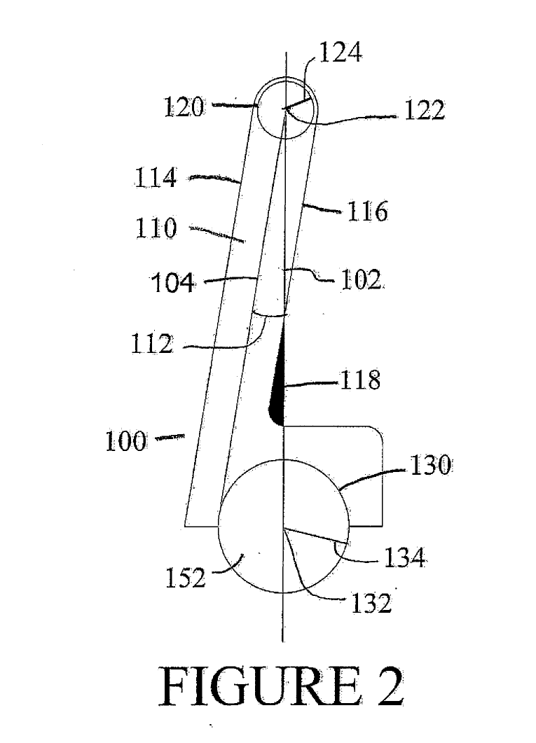

FIG. 2 shows a side view of one (1) embodiment of highly efficient universal connecting rod 100. highly efficient universal connecting rod 100 contains an elongated rod body 110 extending between wrist pin aperture 120 and big end bearing aperture 130. Wrist pin aperture 120 having a center point 122 and radius 124. Big end bearing aperture 130 having a center point 132 and radius 134. Elongated rod body 110 further includes an outer edge 114, an inner edge 116 and an offset line of action 104. Also shown in FIG. 2 is angle of offset 112, which is the angle formed between traditional line of action 102 and offset line of action 104.

FIG. 2 further shows a force transfer area 118 which is a gap or lack of continuity in the material from which elongated rod body 110 is constructed, and which eliminates the traditional line of action found in a conventional connecting rod. Force transfer area 118 redirects the force to an offset line of action 104 created by angle of offset 112 between the line of action in traditional connecting rod and offset connecting rod described herein. In various embodiments, force transfer area 118 may be created by the removal of metal, contouring, milling, molding, forging curvature, an aperture, remanufacturing or by any other structural configuration.

The embodiment of highly efficient universal connecting rod 100 shown in FIG. 2 may be made universal by a method of manufacture disclosed herein which uses the force transfer area equation and angle of offset equation.

The angle of offset equation is an equation pursuant to which the angle of offset 112 is proportional to the distance between wrist pin center point 122 and big end bearing center point 132, and is a calculation which determines the angle sufficient to create an offset line of action 104 which creates an offset torque force resulting in increased efficiency.

The angle of offset equation is as follows:

θ=arcsine(r/L)

In this equation, L is defined as the distance between the center point of the wrist pin aperture 122 and the center point of the big end bearing aperture 132. r is defined as the measure of the radius of the big end bearing aperture 134. θ is defined as the calculated angle of offset.

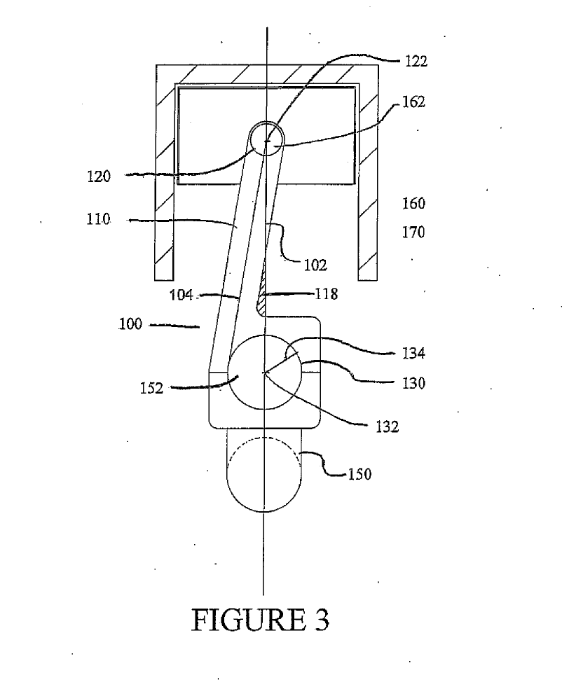

FIG. 3 is a side perspective view of an exemplary embodiment of highly efficient universal connecting rod 100 as fitted within an internal combustion engine, which also shows offset line of action 104. The embodiment shown in FIG. 3 is adaptable to an internal combustion engine using a method of manufacture employing the angle of offset equation and force transfer area equation defined herein. A traditional connecting rod may simply be removed from internal combustion engine and replaced with highly efficient universal connecting rod 100 with no mechanical adaptation to accommodate highly efficient universal connecting rod 100.

While the connecting rod has been shown and described with respect to an illustrative embodiment and used in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. A method of manufacture of highly efficient universal connecting rod comprising the steps of:
a. constructing an connecting rod having an offset longitudinal axis, a line of action, a first circular aperture and a second circular aperture;
b. constructing said first circular aperture used for pivotally attaching said connecting rod to a wrist pin, and said first circular aperture having a center, and a radius;
c. constructing said second circular aperture used to pivotally attach said connecting rod to a big end bearing;
d. constructing said second circular aperture having a center, and a radius; and
e. placing said offset longitudinal axis having an angle of offset creating a force transfer area which directs the line of action to a point away from the center of said second circular aperture in the direction of normal crankshaft rotation to create an offset line of action, said force transfer area calculated as
(½)((0.1)(w))(((0.1)(w))(cot θ))

2. The universal connecting rod of claim 1, wherein said angle of offset is proportional to said radius of said big end bearing connected by said second circular aperture.

3. The universal connecting rod of claim 1, wherein said angle of offset is proportional to the distance between the center point of said first circular aperture and said center point of said second circular aperture.

4. The universal connecting rod of claim 1, wherein said longitudinal axis forms said angle of offset as determined by an angle of offset equation.

5. The universal connecting rod of claim 1, made from a process selected from the group consisting of molding, milling, tooling, machining, forging, extruding, sintering, rapid prototyping, stamping, assembling, remanufacturing and welding.

6. The universal connecting rod of claim 1, wherein said offset longitudinal axis includes said force transfer area formed by a process selected from the group consisting of molding, milling, tooling, machining, forging, extruding, sintering, rapid prototyping, stamping, assembling, remanufacturing and welding.

7. The universal connecting rod of claim 1, wherein said offset longitudinal axis, said first circular aperture and said second circular aperture are proportional to specifications of a specified connecting rod so that said universal connecting rod may be used to replace said specified connecting rod.

8. The universal connecting rod of claim 1, wherein said longitudinal axis, said first circular aperture and said second circular aperture are proportional to specifications of a commercially available connecting rod so that said universal connecting rod may be used to replace said commercially available connecting rod.

9. The universal connecting rod of claim 1, made from a material selected from the group consisting of steel, aluminum, ceramic, plastic and metal alloy.

10. A method of manufacture of a highly efficient universal connecting rod comprising the steps of:
a. calculating a force transfer angle; and
b. forming an offset connecting rod having a force transfer angle which creates a force transfer area.

11. The method of claim 10, further including the step of calculating a force transfer angle proportional to a radius of a big end bearing.

12. The method of claim 10, further including the step of calculating a force transfer angle proportional to the distance between a center point of a first circular aperture and a center point of a second circular aperture.

13. The method of claim 10, further including the step of calculating a force transfer angle such that an offset longitudinal axis contains a force transfer area as determined by a force transfer area equation.

14. The method of claim 10, further including the step of forming the universal connecting rod by a process selected from the group consisting of molding, milling, tooling, machining, forging, extruding, sintering, rapid prototyping, stamping, assembling, remanufacturing and welding.

15. The method of claim 10, further including the step of forming the universal connecting rod proportional to specifications of a commercially available connecting rod so that said universal connecting rod may be used to replace said commercially available connecting rod.

16. The method of claim 10, further including the step of forming the universal connecting rod from a material selected from the group consisting of steel, aluminum, ceramic, plastic and metal alloy.

17. A universal connecting rod constructed using a force transfer area equation, and comprised of:
a. an connecting rod having an offset longitudinal axis, a offset line of action, a first circular aperture and a second circular aperture;
b. said first circular aperture used for pivotally attaching said connecting rod to a wrist pin, and said first circular aperture having a center, and a radius;
c. said second circular aperture used to pivotally attach said connecting rod to a big end bearing, and said second circular aperture having a center, and a radius;
d. said offset longitudinal axis having a force transfer area creating an angle of offset which directs the line of action to a point away from the center of said second circular aperture in the direction of normal crankshaft rotation;
e. said force transfer area determined by a force transfer area equation; and
f. said offset longitudinal axis, said first circular aperture and said second circular aperture are proportional to specifications of a specified connecting rod so that said highly efficient universal connecting rod may be used to replace said specified connecting rod.

18. A method of manufacture of a highly efficient universal connecting rod comprising the steps of:
a. calculating an angle of offset using an angle of offset equation pursuant to which the angle of offset is proportional to the distance between a center point of a first circular aperture for connecting a wrist pin and a center point of a second circular aperture for connecting a big end bearing; and
b. forming an connecting rod having said angle of offset to create a force transfer area.
